(19) United States
(12) Patent Application Publication
(10) Pub. No.: US 2008/0226522 A1
(43) Pub. Date: Sep. 18, 2008

(54) Barium Sulfate Product

(76) Inventor: Michael W. McKee, Alton, IL (US)

Correspondence Address: Mallinckrodt Inc., 675 McDonnell Boulevard, HAZELWOOD, MO, 63042, US

(21) Appl. No.: 12/088,272

(22) PCT Filed: Dec. 11, 2006
(86) PCT No.: PCT/US06/47217

§ 371 Date: Mar. 27, 2008

Related U.S. Application Data
(60) Provisional application No. 60/750,125, filed on Dec. 14, 2005.

(51) Int. Cl. C01F 1/00

(52) U.S. Cl. 423/170

(57) ABSTRACT

This invention generally relates to a barium sulfate product particularly useful as an X-ray contrast agent in preparations administered for examination of the gastrointestinal tract and to processes for making the product from naturally occurring barite ore containing barium sulfate crystals and gangue materials. The process includes treating or contacting the barium sulfate-containing particles obtained from barite ore with a fluidizing agent in a liquid medium to remove gangue materials present therein.

### FIELD OF THE INVENTION

The present invention relates generally to a barium sulfate product and to processes for making the product from barite ore containing barium sulfate crystals and gangue materials. The barium sulfate product can be used in the production of paints, rubbers and drilling fluids for oil and gas exploration and is suitably of medical grade and can be employed in various other applications, including as a component of pharmaceutical, veterinary and cosmetic compositions, particularly where a barium sulfate product having a “whiter” appearance is desired.

### BACKGROUND OF THE INVENTION

Barium sulfate is a radiopaque medium widely used as an X-ray contrast agent in medical examination of the gastrointestinal tract. Generally, for a gastrointestinal examination, the subject undergoing examination drinks a suspension of barium sulfate in water, by itself, or in combination with a carbon dioxide producing agent, such as BAROS effervescent granules (Mallinckrodt, Saint Louis, Mo.). The barium sulfate used is a fine, white, odorless, tasteless bulky powder that is practically insoluble in water, in organic solvents and in acidic and alkaline solutions. It does, however, exhibit some solubility in hot concentrated sulfuric acid. This extremely inert quality of barium sulfate makes it ideal as a radiopaque medium, as it is not absorbable by an intact mucosa and is therefore considered safe to administer for radiological use.

One method used to produce medical grade barium sulfate, sometimes referred to as the Mallinckrodt process, involves dissolving finely divided barite ore into solution by means of an acid and then precipitating the barium ions from solution as barium sulfate using sulfuric acid. Because of the inertness of barium sulfate, this is a very difficult and expensive procedure. Often the barium sulfate precipitate formed still contains many impurities and must be subjected to a number of additional purification steps including acid leaching. In addition, such precipitation processes generally yield a barium sulfate product largely comprised of particles of a size much less than about 1 micron. For use as a contrast agent in preparations for examination of the gastrointestinal tract, particularly examination of the upper gastrointestinal tract, it is often preferred that medical barium sulfate particles be larger than those typically produced by precipitation techniques.

Stone, U.S. Pat. No. 4,119,700, discloses an alternative process for producing a medical barium sulfate product from barite ore that does not require dissolution for purification, but instead isolates crystals of substantially pure barium sulfate present in the ore. The process includes grinding the naturally occurring barite ore containing barium sulfate crystals and gangue minerals to form a granular ore material, passing this granular ore through a high intensity wet magnetic separator to remove magnetic particles, and subjecting the non-magnetic fraction containing barium sulfate and low specific gravity minerals to gravity separation to separate a substantially pure barium sulfate fraction. The process further includes subjecting this barium sulfate fraction to further grinding to achieve the desired particle size distribution (e.g., on the order of about 1 micron), leaching the finely divided barium sulfate fraction with a mineral acid such as sulfuric or hydrochloric acid and washing the leached product with water to neutralize the leaching acid.

Although the teachings of Stone are useful and address some of the problems attendant production of medical barium sulfate by precipitation techniques, the product is not always satisfactory. Sometimes barium sulfate produced in this fashion has a less than desirable off-white or gray coloration. The gray coloration is believed to be attributable to impurities such as silica and other persistent gangue materials from the barite ore. Furthermore, during examination and investigation of the gastrointestinal tract, medical barium sulfate preparations are typically suspended in water for ingestion by the patient. The persistent gangue materials present in the barium sulfate component of the preparation may separate and form an undesirable off-white or gray float material in the suspension to be ingested by the subject undergoing examination.

Accordingly, a need persists for more effective techniques of making a medical barium sulfate product from barite ore having improved appearance (e.g., a more consistent “whiter” color) and other properties that make it more suitable for use as an X-ray contrast agent in preparations for examination of the gastrointestinal tract as well as in other applications requiring a cleaner, whiter barium sulfate product.

### SUMMARY OF THE INVENTION

Briefly, therefore, the present invention is directed to a process for making a barium sulfate product from barite ore containing barium sulfate particles and gangue materials. The process comprises mixing barium sulfate-containing particles obtained from barite ore with a fluidizing agent in a liquid medium to form a treated mixture comprising barium sulfate-containing particles and fluidized gangue materials released from the barium sulfate-containing particles. The fluidized gangue materials are separated from the treated mixture and the barium sulfate-containing particles are dried to produce the barium sulfate product.

In accordance with one preferred embodiment, the process for making a barium sulfate product from barite ore containing barium sulfate particles and gangue materials comprises contacting barite ore particles with a leaching acid to leach acid-soluble impurities and produce a slurry comprising leached barium sulfate-containing particles having a reduced concentration of acid-soluble impurities followed by washing the leached barium sulfate-containing particles with water. The washed barium sulfate-containing particles are mixed with a fluidizing agent in a liquid medium to form a treated mixture comprising barium sulfate-containing particles and fluidized gangue materials released from the barium sulfate-containing particles. The fluidized gangue materials are separated from the treated mixture and the barium sulfate-containing particles are dried to produce the barium sulfate product.

Other features of this invention will be in part apparent and in part pointed out hereinafter.

### BRIEF DESCRIPTION OF THE DRAWING

FIG. 1 is a schematic diagram of a process for making a barium sulfate product from baritc orc containing barium sulfate and gangue materials in accordance with the present invention.

### DETAILED DESCRIPTION OF THE INVENTION

In accordance with the present invention, improved processes for producing barium sulfate products, which are particularly useful as X-ray contrast agents in gastrointestinal tract examinations, have been devised. More specifically, the use of particular fluidizing agents or fluidizers has been discovered as a useful means of reducing the concentration of undesired gangue materials in medical grade barium sulfate products obtained from naturally occurring barite ore that may otherwise undermine the appearance and other desired properties of the product.

The use of a fluidizing agent in accordance with the present invention is readily integrated into known processes for the production of barium sulfate products from barite ore that do not require dissolution and precipitation for purification of the barium sulfate product, but instead isolate substantially pure barium sulfate crystals present in the barite ore. Such processes, including that described by Stone in U.S. Pat. No. 4,119,700, the entire disclosure of which is incorporated herein by reference, are generally known in the art and typically include milling (e.g., crushing and grinding) the barite ore, classifying the milled barium sulfate-containing particles to the desired particle size, contacting the barium sulfate-containing particles with an acid to leach and remove acid-soluble impurities and washing and drying the barium sulfate product. In the practice of the present invention, these process operations may be conducted in a batch, semi-continuous, or continuous mode. The operations may be suitably carried out using a variety of apparatus and process techniques well-known to those skilled in the art and in some instances may be omitted or combined with other operations without departing from the scope of the present invention.

Generally, the process for isolating substantially pure barium sulfate crystals present in the barite ore is modified in accordance with the present invention by mixing barium sulfate-containing particles obtained directly from barite ore (i.e., without requiring precipitation of barium sulfate) with a fluidizing agent in a liquid medium to form a treated mixture comprising barium sulfate-containing particles and gangue materials fluidized or released from the barium sulfate-containing particles. The fluidized gangue materials are typically present in the treated mixture as part of a float layer. The fluidized gangue materials are separated from the treated mixture and thereafter the barium sulfate-containing particles are dried to produce the barium sulfate product. As will be described in greater detail below, treating barium sulfate-containing particles obtained from barite ore with a fluidizer in a liquid medium to release and separate color-forming gangue materials may be integrated in various ways into a process for isolating substantially pure barium sulfate crystals present in the barite ore.

In addition to crystals of substantially pure barium sulfate, naturally occurring barite ore or barytes typically contains many gangue materials, such as large pieces of iron oxides or hydrated iron oxides, iron carbonate, quartz or silica crystals along with aluminum and chromium compound impurities. The iron compounds and the silica may sometimes be associated together (i.e., as nodules or relatively large size pieces of iron silicates). The types of gangue materials and their proportions can vary greatly in relation to the barium sulfate content of the ore, it being appreciated that the lower the amount of barium sulfate present in the ore, the greater amount of ore that will have to be processed to obtain a given amount of barium sulfate product. An exemplary barite ore analysis given by Stone in U.S. Pat. No. 4,119,700 revealed the following components: BaSO₄ 74.4%; FeCO₃ 18.6%; SiO₂ 5.6%; and other miscellaneous gangue materials 1.4%. Generally the oxide and carbonate based impurities present in the ore are removed by acid treatment leaving behind non-acid soluble gangue materials. Regardless of the exact barite ore composition, it is the silica and other gangue materials present in the ore that might otherwise persist in the barium sulfate product and are believed to cause unwanted coloration of the product and the undesirable float material in barium sulfate suspensions administered for gastrointestinal tract examinations.

The fluidizing agent combined with the barium sulfate-containing particles obtained from the barite ore is selected so as to be capable of fluidizing or releasing at least a portion of the gangue materials present and should otherwise be relatively inert and non-harmful should it persist to any significant extent in the barium sulfate product intended for ingestion as part of a gastrointestinal tract examination preparation. The fluidizing agent may be in solid or liquid form (e.g., dissolved in solution) and is dispersible or at least partially soluble, preferably substantially soluble, in the liquid medium in which the barium sulfate-containing particles are treated with the fluidizing agent. Preferably, an aqueous liquid medium comprising water is employed.

In accordance with the present invention, various fluidizing agents have been identified that effectively reduce the concentration of gangue materials in barium sulfate-containing particles obtained from barite ore, particularly silica impurities. These suitable fluidizing agents include natural gums, synthetic and semi-synthetic gums or polymers, biopolymers, chelating agents, salts of polyacid monomers, inorganic salts, and mixtures thereof.

Polymeric fluidizers include natural gums, synthetic and semi-synthetic gums or polymers and biopolymers. Examples of suitable natural gums include carrageenan, alginate, arabic gum, arabic gum treated with NaOH, pectin, and the like, and mixtures thereof. Examples of suitable synthetic and semi-synthetic gums or polymers include low viscosity carboxymethylcelluloses, copolymers of ethylene and either maleic anhydride or maleic acid, such as EMA 31, EMA 31 Na+, EMA 21, EMA 21 Na+, copolymers of methyl vinyl ether and maleic anhydride such as GANTREZ Na+ (GAF Corporation, New York, N.Y.), and the like, and mixtures thereof. Examples of suitable biopolymers include heparin, chondroitin sulfate, and the like, and mixtures thereof.

Other fluidizing agents include chelating agents, salts of polyacid monomers (e.g., salts of polycarboxylates), and inorganic salts. As used herein, polyacid monomers are polycarboxylic acid compounds having 2 to 5 —COOH groups. As used herein, salts are pharmaceutically acceptable salts. Suitable pharmaceutically acceptable salts include alkali metals (e.g., sodium and potassium) alkaline earth metals (e.g., calcium and magnesium) and organic bases (e.g. meglumine). Examples of suitable chelating agents include salts of polyaminocarboxylic acids, such as ethylenediarninetetraacetic acid (EDTA), cyclohexane-trans-1,2-diaminetetraacetic acid (CDTA), diethylenetriaminepentaacetic acid, and the like, other chelating agents such as lactic acid, N-β-ethanolamine-N,N-diacetic acid (e.g., disodium N-β-ethanolamine-N,N-diacetate), and the like, and mixtures thereof. Examples of suitable salts of polyacid monomers include alkali metal and alkaline earth metal salts of citric acid (e.g., sodium citrate), nitrilotriacetic acid (e.g., trisodium nitrilotriacetate), nitrilo-trimethylene triphosphoric acid (e.g., trisodium nitrilo-trimethylene triphosphite), inositol hexaphosphoric acid, N-β-ethanolamine-N,N-diacetic acid (e.g., disodium N-β-ethanolamine-N,N-diacetate), and the like, and mixtures thereof. Suitable inorganic salts include, for example, sodium hexarnetaphosphate, sodium pyrophosphate, sodium tripolyphosphate, and the like, and mixtures thereof. In accordance with one preferred embodiment, the fluidizing agent comprises an alkali metal or alkaline earth metal polycarboxylate salt. Suitable polycarboxylate salts include salts of dicarboxylic acids such as oxalic acid, malonic acid, succinic acid, glutaric acid, adipic acid, and the like, and mixtures thereof, as well as salts of tricarboxylic acids, including, but not limited to, citric acid. Preferably, the polycarboxylate salt includes a hydroxyl substituent. Preferred polycarboxylate salts having a hydroxyl group include salts of citric acid, isocitric acid, tartaric acid, and malic acid.

Examples of particularly suitable fluidizing agents include EMA 21 Na+, GANTREZ Na+, arabic gum treated with NaOH, sodium citrate, trisodium nitrilotriacetate, trisodium nitrilo-trimethylene triphosphite, sodium hexametaphosph ate, sodium pyrophosphate, sodium tripolyphosphate, and inositol hexaphosphorate.

In one preferred embodiment, the fluidizing agent comprises sodium pyrophosphate.

In accordance with an especially preferred embodiment, the fluidizing agent comprises sodium citrate. Sodium citrate has been found to be especially effective in fluidizing or releasing gangue materials, particularly silica, from barium sulfate-containing particles obtained from barite ore. Sodium citrate is also often included as a component of conventional gastrointestinal tract examination preparations to produce a free-flowing X-ray contrast composition. Accordingly, the persistence of some amount of the sodium citrate used as a fluidizer in the barium sulfate product may provide an additional benefit.

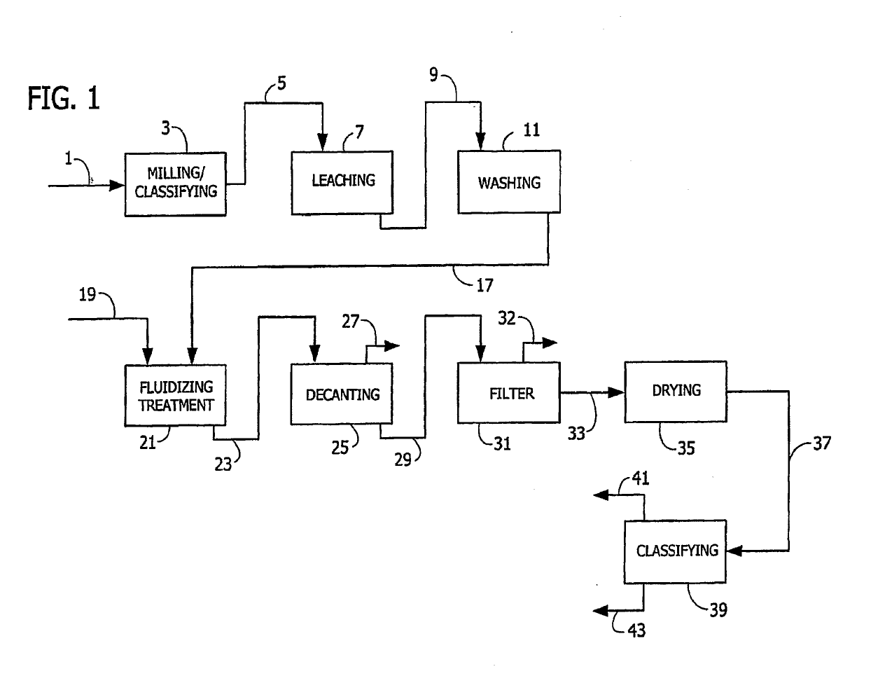

For purpose of illustration of some embodiments of the present invention, a process of making a barium sulfate product from barite ore containing barium sulfate and gangue materials will be described with reference to FIG. 1. FIG. 1 is a schematic diagram of a process for making a barium sulfate product from barite ore including using a fluidizing agent to reduce the concentration of undesired gangue materials. In the embodiment shown in FIG. 1, barium sulfate-containing particles are treated with a fluidizing agent in a liquid medium after the particles are subjected to an acid leaching operation and following neutralization of the leached material.

Barite ore 1 containing barium sulfate and gangue materials, as obtained from the mine, is subjected to a milling and classifying operation 3 to attain barium sulfate-containing ore particles 5 of the desired size distribution. The barite ore can, for example, be subjected to an initial crushing with care being taken to keep the production of fine particles to a minimum. This can be done by means of a jaw crusher followed by a gyratory crusher or other means known in the art. These coarse ore particles may then subjected to grinding, for instance in a ball mill, rod mill or hammer mill, to further reduce their size and produce a granular ore, again with proper care taken to avoid excessive production of fines. After the particles are crushed and ground, the particles are then classified by size to separate the fine particles and over-sized particles from the barium sulfate-containing ore particles of the desired size. Generally, the barium sulfate-containing ore particles subjected to further processing have a particle size distribution that provides efficient acid leaching and allows recovery of a final barium sulfate product having the desired particle size distribution. However, because the final barium sulfate product is typically subjected to a further milling and classifying operation, the particle size distribution of the barium sulfate-containing ore particles subjected to further processing is not narrowly critical.

The milled and classified barium sulfate-containing ore particles 5 are next subjected to an acid leaching operation 7 to reduce the concentration of any acid-soluble gangue materials or impurities, such as acid-soluble barium salts and oxides of iron and/or manganese, in order to meet applicable USP specifications. The acid leaching operation generally comprises contacting the barium sulfate-containing ore particles with a leaching acid in a suitable vessel(s) to leach acid-soluble impurities from the particles and produce a slurry 9 comprising leached barium sulfate-containing particles having a reduced concentration of acid-soluble impurities.

Preferably, the leaching acid comprises a mineral acid. Examples of suitable mineral acids are sulfuric acid and hydrochloric acid. The strength or concentration of the leaching acid used in the leaching operation may vary depending on the composition of the incoming barite ore and the desired composition of the final barium sulfate product. Generally, higher concentrations of leaching acid are required as the concentration of acid-soluble impurities in the barite ore and/or the desired purity of the barium sulfate product with respect to acid-soluble impurities increase. Typically, suitable results are obtained in the leaching operation by contacting the barium sulfate-containing ore particles with sulfuric acid or hydrochloric acid at a concentration sufficient to produce a leaching mixture or slurry having a pH of less than about 3, more preferably less than about 2.

The leaching operation may be carried out in a single stage leaching system in which a slurry comprising barium sulfate-containing ore particles and leaching acid is mixed in a slowly rotating drum. The leaching drum may be adapted to tilt at an angle to drain off or decant and recover the leaching acid after completion of the leaching operation. To reduce acid consumption, the leaching operation can be carried out in multiple stages, for example, a counter-current three-stage leaching operation. In an example of such an operation, the barium sulfate-containing ore particles pass from the first-stage through the second and third-stage and are contacted with leaching acid of increasing concentration. That is, fresh leaching acid is introduced into the final or third-stage and is recovered and passed countercurrent to the barium sulfate-containing ore particles through the second and then first-stages.

The resulting slurry 9 of leached barium sulfate-containing particles is washed with water to at least partially neutralize the leaching acid retained in the slurry. The wash water can be tap water or purified water, such as distilled or deionized, water. As illustrated in FIG. 1, the slurry of leached barium sulfate-containing particles 9 is washed with water in a washing operation 11 to produce a washed slurry 17 comprising leached barium sulfate-containing particles. Like the leaching operation, washing of the leached slurry can be conducted in one or several stages until the desired pH is attained. If washing is conducted in multiple stages, different purity wash water may optionally be used in different stages. For example, the leached barium sulfate-containing particles may be washed with water in the drum or other vessel used in the leaching operation by introducing wash water into the vessel and allowing the water and acid mixture to overflow from the drum. At completion of the washing operation, the vessel can be tilted at an angle to drain off or decant the wash water and recover the leached and washed barium sulfate-containing particles. Alternatively, the slurry of leached barium sulfate-containing particles may be transferred to a separate vessel for the washing operation. Regardless of how the washing operation is conducted, washing is preferably continued to substantially neutralize and increase the pH of the leached material to at least about 6, more preferably to from about 6 to about 7.

In accordance with the embodiment of the present invention illustrated in FIG. 1, the washed barium sulfate-containing particles of slurry 17 are subjected to a fluidizing or peptizing treatment 21 in which the particles are mixed with an appropriate quantity of fluidizing agent 19 in a liquid medium to fluidize or release gangue materials from the barium sulfate-containing particles. The particular construction and configuration of the equipment used to mix the washed barium sulfate-containing particles and the fluidizing agent is not critical in the practice of the present invention. The apparatus used may comprise a suitable vessel, preferably equipped with an agitation device (e.g., a stirred tank). Preferably, an aqueous liquid medium comprising water is utilized in the fluidizing treatment.

In general, the amount of fluidizing agent added to the barium sulfate-containing particles varies depending on the composition of the incoming barite ore used, the desired purity of the barium sulfate product, and the concentration of the barium sulfate-containing particles in the treated mixture. Generally, as the concentration of gangue materials in the barite ore increases, more fluidizing agent may be required. Similarly, if a lower concentration of gangue materials is required in the barium sulfate product, it may be necessary to use more fluidizing agent. Although higher or lower concentrations may be employed, particularly depending on the effectiveness of the specific fluidizing agent used, suitable results are generally achieved when the concentration of the barium sulfate-containing particles is from about 15% to about 65% by weight in the treated mixture and the fluidizing agent used to treat the barium sulfate-containing particles is added in a proportion of at least about 0.03% by weight of the trcatcd mixture, preferably from about 0.05% to about 5% by weight, more preferably from at least about 0.05% to about 0.5% by weight.

The liquid medium in which the washed barium sulfate-containing particles are mixed with the fluidizing agent is suitably maintained at typical temperatures, for example, from at least about 5° C. to about 50° C., and preferably at ambient temperatures of from at least about 15° C. to about 30° C. The fluidizing treatment is allowed to proceed for a time sufficient to thoroughly mix the barium sulfate-containing particles and the fluidizing agent in the liquid medium and to allow the fluidizing agent to release at least a portion of the gangue materials present in the particles to be treated. Typically, the mixture of the barium sulfate-containing particles and the fluidizing agent is contacted for a period sufficient to achieve the desired results, such as, for example, for a period of at least about 15 minutes, and preferably at least about 60 minutes.

The fluidizing treatment produces a treated mixture 23 comprising barium sulfate-containing particles and fluidized gangue materials released from the barium sulfate-containing particles. The fluidized gangue materials include primarily silica, and other optional impurities such as aluminum, chromium, and iron compounds. Upon conclusion of the fluidizing treatment, the fluidized gangue materials are separated from the treated mixture. The equipment and techniques used to separate the fluidized gangue materials from the treated mixture can be any conventional equipment or technique known in the art, and one skilled in the art would be readily able to select a separation operation appropriate in view of overall process considerations. For example, the fluidized gangue materials may be suitably separated from the treated mixture by decantation, filtration, centrifugation or even a combination of such operations. Typically, at least a portion of the gangue materials released from the barium sulfate-containing particles utilizing fluidizing agents in accordance with the present invention are present in a float layer in the treated mixture. Accordingly, separation of the fluidized gangue materials from the treated mixture often includes decantation of the float layer as a viable means of separating at least a portion of the fluidized gangue materials.

In the embodiment shown in FIG. 1, the treated mixture 23 comprising barium sulfate-containing particles and fluidized gangue materials is first subjected to a decantation operation 25 to remove such a float layer 27 from the treated mixture and form a decanted treated mixture 29 that is then subjected to a filtration operation 31 to further remove fluidized gangue materials and other impurities. Decantation of the float layer containing gangue materials released from the barium sulfate-containing particles prior to filtration of the decanted treated mixture reduces the risk of premature blinding of the filtration device.

The particular construction and configuration of the equipment used to decant the float layer 27 from the treated mixture 23 is not critical in the practice of the present invention. For example, the equipment used may comprise a suitable vessel adapted to tilt at an angle to pour off the float layer or the vessel may be provided with a decantation port at a suitable elevation through which the float layer may be drawn off from the treated mixture. Still further, decantation of the float layer may be achieved in a vessel provided with suitable vacuum means. The decantation operation may be carried out in the same vessel in which the fluidizing agent is mixed with the barium sulfate-containing particles. In another embodiment, the treated mixture 23 with the float material may be transferred to another vessel in which the float material is decanted from the treated mixture. The decanting step may optionally be conducted in either a single stage or multiple stages. The water used in the fluidizing treatment and decanting steps may be tap water or purified water, such as distilled or deionized, water. In a multistage process, different purity water may be used in different stages, e.g. the final stage may optionally use purified water.

In the embodiment shown in FIG. 1, the decanted treated mixture 29 is subjected to a filtration operation 31 to further remove any additional impurities and produce a filtrate or dryer feed stream 33 comprising barium sulfate-containing particles. The filtration device is constructed and configured to retain undesirable impurities larger than the barium sulfate-containing particles. In one embodiment, the decanted treated mixture may be filtered through a mesh filter such as a 325 mesh U.S. Standard Sieve Series screen or similar device.

After separation of the fluidized gangue materials from the treated mixture 23, the barium sulfate-containing particles in the dryer feed stream 33 are subjected to a drying operation 35 to produce a dried barium sulfate product 37, typically having a moisture content of no greater than about 2% by weight and containing particles ranging in size of from about 0.5 μm to about 15 μm, although smaller and larger particles may also be present. The particular construction and configuration of the equipment used for drying the barium sulfate-containing particles is not critical in the practice of the present invention and may comprise a steam tube dryer or other suitable industrial drying device.

Once dried, the barium sulfate product 37 may be subjected to a further milling and classification operation 39 to separate and obtain one or more barium sulfate products 41 and 43 having the desired particle size distribution. Alternately, the drying, grinding, and classifying operations may be performed simultaneously. In one embodiment, medical barium sulfate product particles intended for use in a pharmaceutical gastrointestinal examination formulation have a mean particle size of at least about 3 μm, preferably from about 3 μm to about 4.5 μm. In another embodiment, medical barium sulfate product particles have a mean particle size from about 8 μm to about 11 μm.

Although the process for making a barium sulfate product from barite ore illustrated in FIG. 1 shows a preferred embodiment including treatment of the barium sulfate-containing particles with a fluidizing agent after the acid leaching operation and water washing to neutralize the leached material, it should be recognized that the fluidizer treatment may be integrated into the process in other ways without departing from the scope of the present invention. The pH during the fluidizing treatment may impact the ability if the fluidizing agent to release gangue materials from the barium sulfate-containing particles. If the fluidizing treatment occurs prior to complete neutralization of the leached material, it is preferable to choose a fluidizer that is not susceptible to substantially complete protonation at the given pH. For example, in such an embodiment, a fluidizing agent comprising an alkali metal or alkaline earth metal polycarboxylate salt may be less preferred. Furthermore, a conventional process for producing a barium sulfate product from barite ore may be modified in accordance with the present invention by subjecting the dried product to a fluidizing treatment including mixing particles of the barium sulfate product with a fluidizing agent in a liquid medium (e.g., water) and thereafter separating fluidized gangue materials from the treated mixture and drying the treated product. However, this latter alternative embodiment is somewhat less preferred as it would require an additional drying operation and increase the overall operating cost of the process.

Moreover, it should be understood that the treatment of barium sulfate-containing particles with a fluidizer may be carried out multiple times (e.g., serially) within the process scheme to enhance removal of persistent gangue materials from the barium sulfate product. For example, a first treated mixture may be prepared by first mixing the barium sulfate-containing particles with a fluidizing agent and then mixing the treated barium sulfate-containing particles obtained with a second fluidizing agent to form a second treated mixture comprising barium sulfate-containing particles and additional fluidized gangue materials. Fluidized gangue materials (e.g., float layer) may be separated from the first treated mixture prior to contacting the treated barium sulfate-containing particles contained therein with the second fluidizing agent and/or fluidized gangue materials may be separated from the second treated mixture. The fluidizing agents used in each of the fluidizing treatments may be the same, or different fluidizing agents may be employed in the fluidizing treatments.

The barium sulfate product produced in accordance with the present invention is suitable for use in the production of paints, rubbers and drilling fluids for oil and gas exploration, but is particularly suited for use as a radiopaque X-ray contrast agent in preparations administered to patients undergoing medical examination of the gastrointestinal tract. The barium sulfate product of the present invention may be used in liquid formulations as well as in dry formulations that are constituted (e.g., suspended in water) prior to ingestion by the patient. The quality and particle size exhibited by the barium sulfate product of the present invention has been found to be particularly useful in medical examinations of the upper gastrointestinal tract because it provides uniform coating of the gastrointestinal tract and the proper opacification during X-ray examination. In addition, the barium sulfate product of the present invention has a desirable substantially white coloration and is less susceptible to the formation of an off-white or gray float when suspended in water to form a barium sulfate suspension for ingestion by a patient undergoing gastrointestinal examination. This latter characteristic is particularly advantageous in gastrointestinal tract examination formulations that do not, contain a viscosity modifier to keep the barium sulfate particles in suspension. Dry formulations typically do not contain a viscosity modifier. In the absence of a viscosity modifier, the appearance and severity of the gray float is often more pronounced upon suspension of a dry formulation in water. Accordingly, the barium sulfate product of the present invention is particularly useful as a radiopaque X-ray contrast agent in dry gastrointestinal tract examination formulations.

In addition to the barium sulfate product described herein, pharmaceutical preparations for use in gastrointestinal examinations may include other additives known to those skilled in the art to improve suspension properties, mucosal coating adhesion, film thickness properties and patient acceptance and tolerance. These include, for example, stabilizing and suspending agents to prevent settling, viscosity modifiers (e.g., certain gums), fluidizing agents such as sodium citrate and sodium tripolyphosphate, sweeteners, such as sucrose and sorbitol, and flavoring agents to improve palatability, water-soluble salts to prevent foaming, and preservatives and antibacterial agents to extend product shelf-life.

In one embodiment, the barium sulfate product prepared in accordance with the present invention has a substantially reduced concentration of certain gangue materials, particularly silica impurities, which might otherwise persist and undermine the desired appearance (e.g., color) properties of the product. The quantity of undesired, color-forming gangue materials removed in accordance with the present invention relative to the incoming baritc orc will vary depending upon the composition of the ore, the selection of the fluidizing agent and the manner in which the fluidizing treatment(s) are carried out. For example, by practicing the techniques described above, it is possible to remove at least about 80% by weight of the silica and other gangue materials from the barium sulfate starting material, more preferably at least about 90%.

The following examples are simply intended to further illustrate and explain the present invention. The invention, therefore, should not be limited to any of the details in these examples.

### EXAMPLE 1

### Elemental Analysis of Raw Barite Ore, Barium Sulfate Product and “Gray Float”

Raw barite ore was processed conventionally (e.g., without fluidizer treatment) to yield a barium sulfate product. During processing, samples of washing liquid and waste liquid were collected. To determine the elemental components as well as relative levels of each element in the raw barite ore, barium sulfate product, washing liquid, waste liquid, and “gray float”, samples derived from each were subjected to spectrographic analysis using qualitative DC arc emission techniques.

The results of the spectrographic analysis are shown in Table I. In Table I, measured levels of each element are defined qualitatively using abbreviations defined below in Table II.

In Table I, the sample denoted “Wash Water” was derived from a collection of wash liquid samples from the above-described production process. The collected samples were allowed to settle and formed a mixture comprising a clear liquid and solid white powder. “Waste Stream” denotes a sample derived from a collection of waste liquid from the acid wash tank of the above-described production process that contained large gray chunks of solid material. The wet insoluble powder and gray chunks were isolated from the collected wash liquid and waste liquid samples, respectively, and dried. Samples denoted “Float #1” and “Float #2” in Table I are “gray float” samples comprising isolated gray float produced upon suspending pilot formulations containing the barium sulfate product in water. After suspension in water, the gray float material was isolated and allowed to settle to form a mixture comprising an insoluble powder. The wet insoluble powder was similarly removed and dried.

The four dried samples, as well as the raw barite ore and the barium sulfate product were subjected to analysis using DC arc emission techniques. Specimens of each were added to #44UC graphite electrodes. Blank electrodes were prepared in much the same manner for comparison. The blank electrodes and specimen-containing electrodes were burned and emission spectra collected using a Thermo Jarrell Ash AtomComp 2000 DC Arc Spectrometer, which utilizes a Charge Injection Device (CID) detector. The instrumental parameters were as follows: Gas Flush—3.00 s (sheath gas 30% O₂ in Argon); Preburn—0.00 s; Arc Current Sequence—25.0 s at 15 Amps; and Total Integration Time—25.0 s.

TABLE I
Qualitative Elemental Analysis of Barite Ore, Barium Sulfate Product
and Other Samples

| | | | | | | Barium |
|---|---|---|---|---|---|---|
| | | | Wash | Waste | Raw | Sulfate |
| Element | Float #1 | Float #2 | Water | Stream | Barite Ore | Product |
| Al | W-M | W-M | W-M | S | M | W-M |
| B | VF | VF | — | — | — | — |
| Ba | P | P | P | P | P | P |
| Ca | M-S | M-S | M-S | M-S | M-S | M-S |
| Cr | VF | F | VF | M | — | — |
| Cu | — | VF | VF | F | F | — |
| Fe | W | W | W | M-S | M-S | W |
| K | F | F | F | F | F | VF |
| Mg | M-S | S | M-S | VS | VS | M |
| Mn | — | — | — | F | W | — |
| Na | W-M | M | W-M | W-M | W | W |
| P | W-M | — | — | — | — | — |
| Pb | — | — | — | X (very | — | — |
| | | | | faint) | | |
| Si | M-S | M-S | M-S | S | S | M-S |
| Sn | — | — | — | F | — | — |
| Sr | S | S | S | S | S | S |
| Ti | VF | F | — | F | VF | — |

TABLE II
Abbreviations Designating Relative Levels
of Elements in Samples of Table I

| | |
|---|---|
| P | Primary |
| VS | Very Strong |
| S | Strong |
| M-S | Moderate to Strong |
| M | Moderate |
| W-M | Weak to Moderate |
| W | Weak |
| F | Faint |
| VF | Very Faint |
| X | Identification Uncertain |
| — | Element not detected |

Elements not detected in any of these samples included: Ag, As, Au, Be, Bi, Cd, Co, Cs, Gd, Hg, Li, Mo, Ni, Pd, Pt, Rb, Sb, Ta, Ti, V, W, and Zn.

Based on the qualitative analysis presented in Table I, conventional processing of the barite ore resulted in the reduction, and in some cases the elimination, of many of the impurity elements in the barium sulfate product. However, substantial impurity levels, especially of silicon and calcium, persist in the barium sulfate product.

These results merited further quantitative investigation. The raw barite ore, barium sulfate product and the gray chunks isolated from the waste stream were analyzed by inductively coupled plasma-atomic emission spectroscopy (ICP-AES) to determine concentrations of elemental impurities in each sample. In preparation for analysis, a portion of each sample was fused with a sodium carbonatelboric acid blend in a muffle furnace and the resulting melt was dissolved using dilute hydrochloric acid. However, it is noted that the sample preparation for ICP-AES analysis was not completely successful in that a precipitate formed during the dissolution of the melt, although the melt itself appeared clear upon removal from the muffle furnace. The dissolved samples were filtered or decanted and the clear filtrate or decantate subjected to ICP-AES analysis using a Thermo Jarrell Ash Atom 25 Inductively Coupled Plasma Atomic Emission Spectrometer.

The results of the ICP-AES analysis are shown in Table III. Due to the difficulty in completely dissolving the samples subjected to ICP-AES, it is possible that some of the analytes were lost with the precipitates that formed during sample preparation, which would impact the quantitative analysis and reproducibility of the results reported in Table III. Nevertheless, the trends observed during the ICP-AES analysis are consistent with and confirm the qualitative analysis results generated using DC arc emission techniques.

TABLE III
Quantitative Analysis of Barite Ore, Barium
Sulfate Product and Waste Stream

| | | | | | Barium Sulfate | |
|---|---|---|---|---|---|---|
| Element | Waste Stream | | Raw Barite Ore | | Product | |
| Si | 3000 | μg/g | 1000 | μg/g | 400 | μg/g |
| Al | 480 | μg/g | 140 | μg/g | 30 | μg/g |
| Cr | 130 | μg/g | <10 | μg/g | <10 | μg/g |
| Ca | 1400-1800 | μg/g | 1400-1800 | μg/g | 300 | μg/g |
| Fe | 400 | μg/g | 400 | μg/g | 40 | μg/g |

As can be seen from the quantitative analysis, conventional processing of the raw barite ore without fluidizing treatment can reduce the concentrations of major impurities such as silicon, calcium, and iron. These elements appear in high concentration in the waste stream and in lower concentration in the barium sulfate product. However, it is difficult using conventional processing to adequately remove the elements, such as silicon, believed to impair the appearance of the barium sulfate product and cause “gray float” upon suspension of the barium sulfate product in water.

### EXAMPLE 2

### Fluidizing Treatment of Barium Sulfate Product to Remove “Gray Float” Impurities

A barium sulfate product (11 g) processed conventionally (e.g., without fluidizer treatment) from barite ore was mixed with water (500 mL) and sodium citrate (3 g) in a beaker. The solution was stirred with a mechanical stirrer, and a “gray float” layer formed above the suspension. The suspension was passed through a 120 mesh (125 μm) screen, which readily separated the “gray float” material The filtrate, comprising suspended barium sulfate particles was substantially clear and free of the “gray float” material.

The above description of the preferred embodiments is intended only to acquaint others skilled in the art with the invention, its principles, and its practical application, so that others skilled in the art may adapt and apply the invention in its numerous forms, as may be best suited to the requirements of a particular use. The present invention, therefore, is not limited to the above embodiments, and may be variously modified.

With reference to the use of the word(s) “comprise” or “comprises” or “comprising” in this specification (including the claims), Applicants note that unless the context requires otherwise, those words are used on the basis and clear understanding that they are to be interpreted inclusively, rather than exclusively, and that Applicants intend each of those words to be so interpreted in construing this specification (including the claims).

1. A process for making a barium sulfate product from barite ore containing barium sulfate particles and gangue materials, the process comprising:
mixing barium sulfate-containing particles obtained from barite ore with a fluidizing agent in a liquid medium to form a treated mixture comprising barium sulfate-containing particles and fluidized gangue materials released from the barium sulfate-containing particles;
separating the fluidized gangue materials from the treated mixture; and
drying the barium sulfate-containing particles to produce the barium sulfate product;
wherein the fluidizing agent is selected from the group consisting of natural gums, synthetic and semi-synthetic gums or polymers, biopolymers, chelating agents, salts of polyacid monomers, inorganic salts, and mixtures thereof.

2. (canceled)

3. The process as set forth in claim 1 wherein the fluidizing agent comprises a natural gum selected from the group consisting of carrageenan, alginate, arabic gum, pectin, and mixtures thereof.

4. The process as set forth in claim 1 wherein the fluidizing agent comprises a synthetic or semi-synthetic gum selected from the group consisting of low viscosity carboxymethylcelluloses, copolymers of ethylene and maleic anhydride, copolymers of ethylene and maleic acid, copolymers of methyl vinyl ether and maleic anhydride, and mixtures thereof.

5. The process as set forth in claim 1 wherein the fluidizing agent comprises a biopolymer selected from the group consisting of heparin, chondroitin sulfate, and mixtures thereof.

6. The process as set forth in claim 1 wherein the fluidizing agent comprises a chelating agent selected from the group consisting of salts of ethylenediaminetetraacetic acid, salts of cyclohexane-trans-1,2-diaminetetraacetic acid, salts of diethylenetriaminepentaacetic acid, and mixtures thereof.

7. The process as set forth in claim 1 wherein the fluidizing agent comprises an inorganic salt selected from the group consisting of sodium hexametaphosphate, sodium pyrophosphate, sodium tripolyphosphate, and mixtures thereof.

8. The process as set forth in claim 7 wherein the fluidizing agent comprises sodium pyrophosphate.

9. The process as set forth in claim 1 wherein the fluidizing agent comprises a salt of a polyacid monomer.

10. The process as set forth in claim 9 wherein the fluidizing agent comprises a salt of a polyacid monomer selected from the group consisting of alkali metal and alkaline earth metal salts of nitrilotriacetic acid, nitrilo-trimethylene triphosphoric acid, inositol hexaphosphoric acid, N-β-ethanolamine-N,N-diacetic acid, and mixtures thereof.

11. The process as set forth in claim 9 wherein the fluidizing agent comprises a polycarboxylate salt.

12. The process as set forth in claim 11 wherein the fluidizing agent comprises a polycarboxylate salt selected from the group consisting of alkali metal and alkaline earth metal salts of oxalic acid, malonic acid, succinic acid, glutaric acid, adipic acid, citric acid, isocitric acid, tartaric acid, malic acid, and mixtures thereof.

13. The process as set forth in claim 12 wherein the fluidizing agent comprises sodium citrate.

14. The process as set forth in claim 1 wherein the treated mixture comprises from about 15% to about 65% by weight of the barium sulfate-containing particles and the fluidizing agent is added in a proportion of at least about 0.03% by weight of the treated mixture.

15. The process as set forth in claim 14 wherein the fluidizing agent is added in a proportion of from about 0.05% to about 0.5% by weight of the treated mixture.

16. The process as set forth in claim 1 wherein fluidized gangue materials released from the barium sulfate-containing particles are present in a float layer in the treated mixture.

17. The process as set forth in claim 16 wherein fluidized gangue materials are separated from the treated mixture by decanting at least a portion of the float layer from the treated mixture.

18. The process as set forth in claim 1 wherein the process further comprises contacting barium sulfate-containing particles obtained from barite ore with a leaching acid to leach acid-soluble impurities and produce a slurry comprising leached barium sulfate-containing particles having a reduced concentration of acid-soluble impurities; and
washing the leached barium sulfate-containing particles with water.

19. The process as set forth in claim 18 wherein the leaching acid comprises a mineral acid selected from the group consisting of hydrochloric acid and sulfuric acid.

20. The process as set forth in claim 1 wherein the treated mixture comprises a first treated mixture, the process further comprising mixing barium sulfate-containing particles obtained after separation of the fluidized gangue materials from the first treated mixture with a second fluidizing agent to form a second treated mixture comprising barium sulfate-containing particles and fluidized gangue materials released from the barium sulfate-containing particles; and
separating the fluidized gangue materials from the second treated mixture.

21. The process as set forth in claim 1 wherein the barium sulfate product comprises particles having a mean particle size of from about 3 μm to about 4.5 μm or from about 8 μm to about 11 μm.

22. A process for making a barium sulfate product from barite ore containing barium sulfate particles and gangue materials, the process comprising:
contacting barite ore particles with a leaching acid to leach acid-soluble impurities and produce a slurry comprising leached barium sulfate-containing particles having a reduced concentration of acid-soluble impurities;
washing the leached barium sulfate-containing particles with water;
mixing the washed barium sulfate-containing particles with a fluidizing agent in a liquid medium to form a treated mixture comprising barium sulfate-containing particles and fluidized gangue materials released from the barium sulfate-containing particles;
separating the fluidized gangue materials from the treated mixture; and
drying the barium sulfate-containing particles to produce the barium sulfate product;
wherein the fluidizing agent is selected from the group consisting of natural gums, synthetic and semi-synthetic gums or polymers, biopolymers, chelating agents, salts of polyacid monomers, inorganic salts, and mixtures thereof.

23. (canceled)

24. The process as set forth in claim 22 wherein the fluidizing agent comprises a natural gum selected from the group consisting of carrageenan, alginate, arabic gum, pectin, and mixtures thereof.

25. The process as set forth in claim 22 wherein the fluidizing agent comprises a synthetic or semi-synthetic gum selected from the group consisting of low viscosity carboxymethylcelluloses, copolymers of ethylene and maleic anhydride, copolymers of ethylene and maleic acid, copolymers of methyl vinyl ether and maleic anhydride, and mixtures thereof.

26. The process as set forth in claim 22 wherein the fluidizing agent comprises a biopolymer selected from the group consisting of heparin, chondroitin sulfate, and mixtures thereof.

27. The process as set forth in claim 22 wherein the fluidizing agent comprises a chelating agent selected from the group consisting of salts of ethylenediaminetetraacetic acid, salts of cyclohexane-trans-1,2-diaminetetraacetic acid, salts of diethylenetriaminepentaacetic acid, and mixtures thereof.

28. The process as set forth in claim 22 wherein the fluidizing agent comprises an inorganic salt selected from the group consisting of sodium hexametaphosphate, sodium pyrophosphate, sodium tripolyphosphate, and mixtures thereof.

29. The process as set forth in claim 28 wherein the fluidizing agent comprises sodium pyrophosphate.

30. The process as set forth in claim 22 wherein the fluidizing agent comprises a salt of a polyacid monomer.

31. The process as set forth in claim 30 wherein the fluidizing agent comprises a salt of a polyacid monomer selected from the group consisting of alkali metal and alkaline earth metal salts of nitrilotriacetic acid, nitrilo-trimethylene triphosphoric acid, inositol hexaphosphoric acid, N-β-ethanolamine-N,N-diacetic acid, and mixtures thereof.

32. The process as set forth in claim 30 wherein the fluidizing agent comprises a polycarboxylate salt.

33. The process as set forth in claim 32 wherein the fluidizing agent comprises a polycarboxylate salt selected from the group consisting of alkali metal and alkaline earth metal salts of oxalic acid, malonic acid, succinic acid, glutaric acid, adipic acid, citric acid, isocitric acid, tartaric acid, malic acid, and mixtures thereof.

34. The process as set forth in claim 33 wherein the fluidizing agent comprises sodium citrate.

35. The process as set forth in claim 22 wherein the treated mixture comprises from about 15% to about 65% by weight of the barium sulfate-containing particles and the fluidizing agent is added in a proportion of at least about 0.03% by weight of the treated mixture.

36. The process as set forth in claim 35 wherein the fluidizing agent is added in a proportion of from about 0.05% to about 0.5% by weight of the treated mixture.

37. The process as set forth in claim 22 wherein fluidized gangue materials released from the barium sulfate-containing particles are present in a float layer in the treated mixture.

38. The process as set forth in claim 37 wherein fluidized gangue materials are separated from the treated mixture by decanting at least a portion of the float layer from the treated mixture.

39. The process as set forth in claim 22 wherein the leaching acid is a mineral acid selected from the group consisting of hydrochloric acid and sulfuric acid.

40. The process as set forth in claim 22 wherein the leached barium sulfate-containing particles are washed with water to at least partially neutralize the slurry before mixing the leached barium sulfate-containing particles with the fluidizing agent in the liquid medium to form the treated mixture, the liquid medium comprising water.

41. The process as set forth in claim 40 wherein the pH of the at least partially neutralized slurry is at least about 6.

42. The process as set forth in claim 41 wherein the pH of the at least partially neutralized slurry is from about 6 to about 7.

43. The process as set forth in claim 40 wherein the temperature of the liquid medium in which the leached barium sulfate-containing particles are mixed with the fluidizing agent is from about 15° C. to about 30° C.

44. The process as set forth in claim 40 wherein the treated mixture comprises a first treated mixture, the process further comprising mixing barium sulfate-containing particles obtained after separation of the fluidized gangue materials from the first treated mixture with a second fluidizing agent to form a second treated mixture comprising barium sulfate-containing particles and fluidized gangue materials released from the barium sulfate-containing particles; and
separating the fluidized gangue materials from the second treated mixture.

45. The process as set forth in claim 22 wherein the barium sulfate product comprises particles having a mean particle size of from about 3 μm to about 4.5 μm or from about 8 μm to about 11 μm.

46. A pharmaceutical formulation for use in gastrointestinal examinations comprising an X-ray contrast agent comprising the barium sulfate product produced in accordance with any one of claim 1 to 45.
